(19) United States
(12) Patent Application Publication
(10) Pub. No.: US 2010/0276934 A1
(43) Pub. Date: Nov. 4, 2010

(54) SYSTEM FOR GENERATING ELECTRIC POWER FROM FLUID CURRENT

(75) Inventor: Joseph Allen Francis, Ruston, WA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: GREEN HYDROPOWER INCORPORATED, Ruston, WA (US)

(21) Appl. No.: 12/648,133

(22) Filed: Dec. 28, 2009

Related U.S. Application Data
(60) Provisional application No. 61/214,981, filed on Apr. 29, 2009.

(51) Int. Cl. F03B 13/00; F03B 13/26

(52) U.S. Cl. 290/54; 290/53

(57) ABSTRACT

A system for generating electric power from a fluid current may include a main line, leader lines, drag elements, and trip lines. The system may further include a rotating body that is in contact with the main line. And the rotating body may be adapted to rotate when the main line is set in motion by the fluid current. The system may also include an electric generator that is driven by the rotating body.

### CROSS REFERENCE TO RELATED APPLICATIONS

This application claims priority to Provisional Application Ser. No. 61/214,981, entitled “Sea Anchor Tidal Power,” by Joseph A. Francis, filed Apr. 29, 2009, which is incorporated herein by reference in its entirety.

### TECHNICAL FIELD

This invention relates generally to the renewable energy field, and more particularly to the sector known as tidal power.

### BACKGROUND

In the last decade tidal power has become an area of interest in the renewable energy field. Tidal power refers generally to the idea of harnessing kinetic energy from a water current and converting it to electricity. Very large tidal currents can be found in many places around the world. Examples include the Bay of Fundy in Nova Scotia, the Pentland Firth in Northern Scotland, the Cook Inlet in Alaska, the Discovery Passage in British Columbia, the Alderney Islands near France, and the Gulf Stream along the East Coast of the United States. Tidal bodies can also be found in Korea, Ireland, Italy, Chile, and many other places around the world.

Some forms of tidal power technology use submerged turbines to generate electricity from water currents. These systems are analogous to windmills or wind generators, which transform the movement of air into useful work or electricity. However, because the density of water is nearly three orders of magnitude higher than that of air, much lower velocities are needed for underwater turbines relative to their wind counterparts. Additionally, compared to other clean energy technologies—such as solar power or wind energy—tidal flows are more predictable, making tidal power a more reliable source of renewable energy.

Despite being a promising source of renewable energy, tidal power is not widely used. This lack of widespread acceptance in the market is due in part to the high infrastructural costs associated with some tidal power systems. Moreover, some of these systems have a very heavy ecological footprint. As a result, there exists a need for tidal power systems that are eco-friendly and that do not require large amounts of capital investment.

Relevant to the present invention are various devices in common use in the marine industry, for example, sea anchors, which have historically been used to steady ships in heavy storms, in many cases preventing vessels from capsizing. Sea anchors can be thought of as underwater parachutes and can also be used to keep ships from wind-drifting long distances when not under their own power. The main components of a sea anchor are shroud lines and a flexible canopy, which may be made in many different diameters depending on the size of the ship in which it is used. A small sea anchor, for example, may have a four-foot diameter for a small 20-foot boat, while a very large sea anchor may have a two-hundred-foot diameter for a ship of up to 3,000 tons. The larger sea anchors may be made with very high strength synthetic materials capable of withstanding significant forces and stress from large masses of water. Sea anchors can transfer large hydrodynamic forces to a vessel through a line commonly referred to as a rode line. A rode line is typically attached at one end to the bow of the ship and at the other end to the shroud lines of the sea anchor.

Materials used for constructing sea anchors are resistant to harsh saltwater environments and do not rust or corrode. When a sea anchor is deployed in the water, the tension of the rode line attached to the bow of the ship enables the sea anchor to open in a way similar to that of an underwater parachute. For a greater ability to adjust its orientation underwater, many sea anchors are equipped with a swivel between the shroud lines and the rode line.

Some well know manufacturers of sea anchors include Fiorentino Para Anchors (California), Para-Tech Engineering Company (Colorado), and W. A. Coppins Para Sea Anchors (New Zealand).

Also commonly used in the marine industry are high performance offshore synthetic ropes. In the last few decades, synthetic ropes have equaled or surpassed the tensile strength of similarly sized wire ropes. Synthetic ropes have the advantage of being much lighter and some have the ability to float. They do not rust or corrode in harsh saltwater environments and they are easier to handle than wire ropes. Synthetic ropes are very strong, durable and come in many different types of lays, braids, colors, lengths, strengths, and diameters. They can be engineered for very specific uses or may be designed for very broad applicability. Well-known manufacturers of synthetic ropes include Samson Rope Company (Washington) and Puget Sound Rope Company (Washington).

The present invention fills a void in the development of tidal power. Unlike underwater turbines or other similar devices, the present invention is cost effective and eco-friendly. It does not require significant amounts of equipment or man hours to install, remove, operate, or maintain. In addition, many components of the invention can be obtained off the shelf. And each of those components has a long and proven track record of use in the harsh saltwater environment. Furthermore, the invention has a small environmental footprint with very small risks to sea life. And the invention may be adapted to be removed completely from a tidal body of water at any time, in a matter of a few hours. The invention has the ability to produce very large amounts of electricity—in the multiple megawatt range.

### SUMMARY

A system for generating electric power from a fluid current is disclosed. The system includes: a main line, leader lines, drag elements, and trip lines. Each leader line has a proximal end and a distal end. Each drag element has a current-facing surface and a current trailing surface. Each trip line has a first end and a second end. Each proximal end of each leader line is operatively connected to the main line and each drag element is operatively connected to the distal end of a corresponding leader line. The first end of each trip line is operatively connected to a corresponding drag element and each second end is operatively connected to the main line. Each drag element is capable of resisting the force of a fluid current when its current-facing surface is exposed to a fluid current. The drag elements may be designed to be detached from their corresponding leader lines, trip lines and/or main line. And the main line is adapted to operatively connect to at least one rotating body and to an electric generator.

The system may also include a rotating body that is in contact with the main line. And the rotating body may be adapted to rotate when the main line is set in motion by the fluid current. The system may also include an electric generator that is driven by the rotating body. The system disclosed may have drag elements in the form of sea anchors, each sea anchor having shroud lines and a flexible canopy. Drag elements may be adapted to expand when their current-facing surfaces are exposed to a fluid current. Weak links having a tensile strength below the tensile strength of the drag elements may also be used and may be adapted to break when subjected to tension above their tensile strength.

A method for generating electric power from a fluid current is also disclosed. The method comprises the steps of deploying drag elements into a fluid current, allowing the drag elements to expand in the presence of the fluid current, and allowing at least a portion of a main line to move in the direction of the water current. The drag elements are connected to the main line through leader lines and trip lines. The main line is adapted to be connected to a rotating body, which rotates when in contact with the main line. The rotating body may in turn drive an electric generator.

### BRIEF DESCRIPTION OF THE DRAWINGS

FIG. 1 is a side view of a first embodiment of the present invention illustrating certain aspects of a single-point deployment system for generating electric power.

FIG. 1a is an enlarged view of portion X of the system shown in FIG. 1 illustrating aspects of the present invention.

FIG. 1b is an enlarged view of portion Y of the system shown in FIG. 1 illustrating aspects of the present invention.

FIG. 2 is a side view of a second embodiment of the present invention illustrating certain aspects of a two-point deployment system for generating electric power.

FIG. 2a is a side view of a variation of the second embodiment of the present invention illustrating certain aspects of a two-point deployment system for generating electric power.

FIG. 2b is a side view of a variation of the second embodiment of the present invention illustrating certain aspects of a system for generating electric power in a body of water with one-directional current.

FIG. 3 is a side view of a third embodiment of the present invention illustrating certain aspects of a single-point deployment system for generating electric power.

### DETAILED DESCRIPTION OF ILLUSTRATIVE EMBODIMENTS

The present invention utilizes a number of drag elements which may be deployed underwater. These drag elements are each attached to an elongated line, i.e., a main line. As the drag elements move due to the movement of a water current, they may exert linear force on the main line to which they are attached. The main line is connected to a rotating body, which rotates as the main line moves. The rotating body, in turn, drives a generator that produces electricity. Various embodiments of the present invention use sea anchors as the drag elements. Some embodiments of the present invention may use a drum, pinch sheave, bullwheel, or capstan as the rotating body. Additionally, the invention may also use electric generators, speed increasers, and other machinery which may be placed above sea level, such that mechanical components are not exposed to the harsh underwater saline environment.

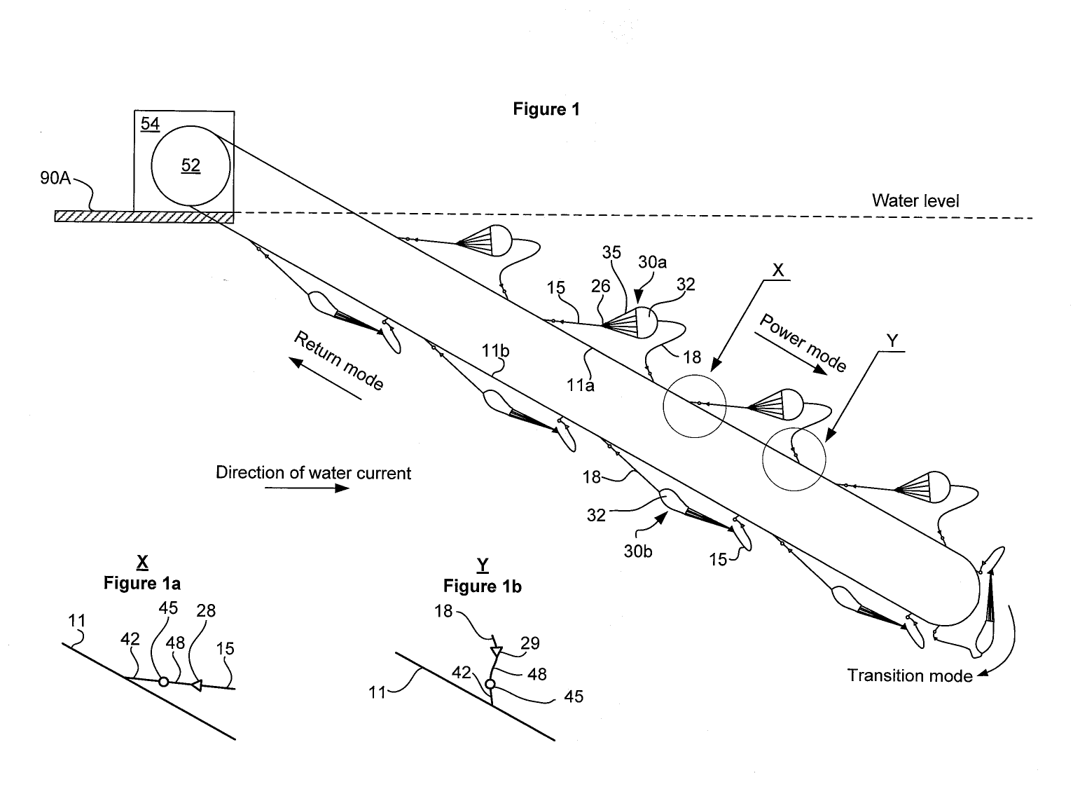

FIG. 1 shows an embodiment of the present invention in which a number of sea anchors 30 are deployed in a moving tidal stream. These anchors are attached to a main line 11, which can be made, for example of synthetic materials, i.e., synthetic rope. The main line 11 transfers the tidal movement from the sea anchors into rotational movement of a rotating body 52, which may be a drum, pinch sheave, bullwheel or capstan, for example. The rotating body in turn drives an electrical generator 54 to produce electricity.

The system shown in FIG. 1 uses a main line 11 routed in a continuous loop with sea anchors 30 attached and deployed in a water current from a single point of deployment 90A.

In the embodiment shown in FIG. 1, the sea anchors 30 are attached to the main line 11 and deployed in a moving tidal current. Each sea anchor 30 shown in FIG. 1, has a canopy 32 and a plurality of shroud lines 35. Each sea anchor 30 may be submerged in the water and allowed to drift in the direction of the water current. During the initial deployment, certain amount of tension is allowed to build on the main line 11 such that the sea anchors 30 expand with a rush of water current upon the underbelly, or current-facing surface, of the canopy 32. The expanded sea anchors 30a exert a hydrodynamic (i.e., drag) force in the opposite direction as that of the water current. This in turn places a tensile load on the main line 11 which is in contact with a rotating body 52. Once the main line 11, is in full tension due to the force exerted on it by the expanded sea anchors 30a, the rotating body 52 starts to rotate and converts the movement of the main line 11 into rotational power. The rotating body 52 drives a generator 54 which produces electricity or other form of useful work.

Expanded sea anchors 30a moving in the direction of the water current are said to be in power mode. When in power mode, leader lines 15—which extend from the main line 11 to the expanded sea anchors 30a—are in full tension. The leader lines 15, are operatively connected at one end to the main line 11 and at the other end to a cone 26, which may be made of stainless steel. The shroud lines 35 of each sea anchor 30 are grouped together at the corresponding cone 26. A leader line 15 allows the sea anchor 30 the space that it needs to expand and to be far enough from the main line 11 in power mode to avoid chafing of the sea anchor 30 from rubbing against the main line 11. The length of a leader line 15 may vary depending on the diameter of the sea anchors 30 used. As shown in FIG. 1, a leader line 15 is in tension when its corresponding sea anchor 30 is in power mode and under minimal or no tension when its corresponding sea anchor 30 is in return mode—that is, moving in the direction opposite that of the water current.

As shown in FIG. 1a, a leader line swivel 28 may be placed between the main line 11 and the leader line 15. Also shown in FIG. 1, is a line that connects the canopy 32—on the side of the current-trailing surface—of the sea anchor 30 to the main line 11. Such a line is known as a trip line 18. As seen in FIG. 1b, a second swivel, known as a trip line swivel 29 may be placed between the main line 11 and the trip line 18. Yet a third swivel (not shown) may be placed between the cone 26 and the leader line 15. Swivels may generally be made of stainless steel.

Sea anchors in power mode 30a are pulled by the force of the moving water current and they in turn pull the main line 11 which rotates the rotating body 52 that drives a generator 54 to produce electricity or other useful work. Once in return mode, the sea anchors in return mode 30b are pulled by the trip lines 18 that are attached to the main line 11 and which—in return mode—are in tension. The sea anchors in return mode 30b cause minimal drag since their canopies 32 are collapsed. Once the sea anchors 30 complete their return mode phase, they are once again deployed as sea anchors in power mode 30a in a continuous cycle.

In the system shown in FIG. 1, the sea anchors 30 are deployed on a main line 11 in power mode. When the sea anchors 30 open (or expand) due to the current, they exert a pulling force on the main line 11 to which they are connected by leader lines 15. While in power mode, the trip lines 18—which are connected to the canopy 32 of the sea anchors 30—are in a slack state. When the sea anchors reach the end of the main line 11 in power mode, the sea anchors 30 transition into return mode. At that point, the sea anchors 30 collapse and are pulled by trip lines 18 connected to the main line. In return mode, the leader lines 15 are in a slack state. In most situations, the sea anchors 30 return to the rotating body 52 while being pulled by the trip lines 18 which are in a tension state. Once the sea anchors 30 reach the generator station located at point 90A in FIG. 1, they may be systematically detached from the main line 11 in return mode. This prevents the sea anchors 30 from running through the rotating body 52. As the sea anchors 30 are detached, they are then reattached to the main line in power mode 11a. Once attached to the main line in power mode 11a, the sea anchors 30 expand and pull the main line 11. When the main line 11 is moved by the force exerted on the anchors 30 by the tidal current or the river current, the rotating body 52 rotates and drives an electric generator 54 that produces electricity.

As shown in FIGS. 1a and 1b, weak links 48 may be used to attach the swivels 28 and 29 to the main line 11, such that that the swivels are within a few feet of the main line 11. The weak link 48 may provide protection to the sea anchor 30 in cases where the main line in power mode 11a comes to a complete stop or the hydrokinetic force pushing against an expanded (or open) sea anchor 30a in power mode is so extreme as to risk destroying the sea anchor 30 or causing it considerable damage. The weak link 48 may have a tensile strength and breaking point just below the breaking point of the sea anchor's shroud lines 35 and/or canopy 32. This may enable the weak link 48 to break and release the extreme tension on the sea anchor 30 such that it prevents the canopy 32 and/or shroud lines 35 from being damaged. The weak link 48 may be easily replaced and the particular sea anchor 30 placed into normal operation very quickly when it reaches the point of deployment 90A—which may be, for example, a shore-based area or the stern of an anchored vessel—by means of an attached trip line 18 that would be in a tension state. Additionally, a spare sea anchor may be used in this type of situation, allowing for a quick replacement, and also may allow a damaged sea anchor to be repaired and set up as a spare such that it is ready to be placed in service when necessary.

As shown in FIGS. 1a and 1b, quick releases 45 may be used to operatively detach and attach the leader line 15 and/or trip line 18 to the main line 11 rapidly, securely, and reliably. Some of the quick releases 45 are better known in the marine industry as C-links, b-links, safety hooks, locking hooks, custom-made bolt-on setups, or custom-made cam-lock-type setups. These quick releases 45 operatively attach to the main line 11 securely and do not allow the leader line 15 or trip line 18 to move from its set position on the main line 11. As shown in FIGS. 1, 1a, and 1b, in some cases, a short piece of rope or line known as a spliced line 42 may be spliced into the main line 11. This short piece of rope or line may be the place where a quick release C-link, quick release D-link, safety hook or locking hook may attach. In some cases a simple knot may be used. Such a knot may be easily tied to the short piece of rope or line that is spliced to the main line 11. Leader lines 15, trip lines 18, as well as weak links 48 are examples of lines or ropes that may be tied to the short piece of rope or line rather than using a hardware-type quick release.

In embodiments such as the one shown in FIG. 1 where the main line 11 is in a continuous loop—and routed around a rotating body 52—friction may be generated between the main line 11 and the rotating device that drives the generator 54 to make electricity. In such cases, the trip line 18 and the leader line 15 may need to be detached from the main line 11 in return mode prior to being pulled into the rotating body 52. Subsequently, the leader line 15 and the trip line 18 may need to be reattached to the main line 11 in power mode as the main line 11 comes out of the rotating body 52. When the main line 11 is in return mode, the collapsed sea anchor 30b is pulled by the trip line 18 that is attached to the main line 11 by means of a quick release 45. As this trip line's quick release nears the rotating body 52, the quick release 45 may be disconnected from the main line in return mode 11b and in a very short time reattached to the main line in power mode 11a. Shortly thereafter, the leader line 15 may be pulled above water by the main line in return mode 11b. The leader line 15 may also be detached by means of a quick release 45 and prevented from being pulled into the rotating body 52 and very shortly thereafter reattached to the main line in power mode 11a as it leaves the rotating body 52.

In systems using rotating devices such as a drum winch, traction winch or capstan, it may be necessary to use multiple wraps or revolutions of the main line 11 around such a device to generate enough friction such that the main line 11 does not slip on the surface of the rotating body 52. A way to eliminate the need to detach and reattach the trip line 18 and leader line 15 from the main line 11 before and after the rotating body 52 is to utilize less than one full revolution of the main line 11 in a friction-type device. The single revolution device would need to create enough friction on the main line 11 as to prevent it from slipping. This may be accomplished with a rotating body 52 known as a powered pinch sheave block, powered crab block or powered longline block found in the commercial fishing industry. In such devices, one side is open and the other side has the supporting shaft and bearings for the tapered sheaves that pinch the main line 11, allowing items connected or spliced to the main line 11 to pass through the device without entanglements or twists. To increase the friction between the main line 11 and the powered pinch sheave block, a large diameter pinch sheave may be used such that there is a large surface area of contact between the pinch sheave and the main line 11. This may prevent the main line 11 from slipping. Such a pinch sheave may be manufactured and adapted to work with certain types of main lines 11 engineered for use in a powered pinch sheave block.

The system in FIG. 1 may be deployed in a single tidal current or river current from a single deployment point 90A such as a shoreline, an anchored vessel, or some other stationary platform, for example. In a river, this system will typically operate in one direction, as a freshwater river generally flows in one direction. The single tidal current shoreline can be used in both flooding or ebbing tidal flow conditions. In saltwater tidal bodies, the system may use roller guides for the main line 11, both in power mode as well as in return mode. Additionally the drum winch, traction winch, pinch sheave block, bullwheel, or capstan may be made to pivot such that it lines up with the direction of the tidal flow, either ebbing or flooding.

In the embodiment shown in FIG. 1, the system used for generating electricity is mounted on a single point of deployment 90A. This single point of deployment 90A may be a shoreline, or in some cases a test vessel that is anchored to the sea floor or tethered to a shoreline within a tidal or river current stream, or possibly a permanent vessel that is anchored to the sea floor. In some instances, it may be cost effective to use a single shoreline rather than a large vessel. A single shoreline may be easier to operate and maintain. Such a system would have no adverse effects on the seafloor. In addition, the system shown in FIG. 1 requires minimal capital investment, as the main expenses relate to the cost of the main line, the sea anchors and one power-generating facility.

The main line 11 of the system shown in FIG. 1 is adapted to work in a continuous loop. Therefore, the length of the main line 11 and the number of sea anchors 30 to be used is determined by how far from the single deployment point 90A the main line in power mode 11a extends. At the farthest point from the point 90A, the main line 11 transitions from a power mode to a return mode. In return mode, the sea anchors collapse in part because of the tension exerted by the trip lines 18. In their collapsed closed state, these sea anchors become sea anchors in return mode 30b and travel in the direction opposite that of the water current. Since the main line 11 in a single-point deployment system, such as the one shown in FIG. 1, works in a continuous loop, part of the work done by the sea anchors in power mode 30a is expended in moving the sea anchors in return mode 30b against the water current. In return mode, trip lines 18 are important in ensuring the collapse—and thus minimal drag—of sea anchors 30b. Collapsed sea anchors 30b, exert minimal drag.

A single-point deployment system, such as the one shown in FIG. 1, may be adapted to take advantage of changes in current flow direction. This may be accomplished by using a pivoting rotating body 52 capable of changing direction depending on the direction of the water current. This pivoting feature may be designed and engineered based on the requirements of the individual power site.

Some embodiments of the system for generating electricity of the present invention may have two stationary points. The stationary points may be, for example—but not limited to—two anchored vessels, two shorelines, two stationary platforms, or any combination thereof. A generator station may be placed on at least one stationary point. If only one generator station is used, the second station may have a rotating drum, block, open-end pinch sheave block, or pulley-type device to reroute the main line to the shoreline, anchored vessel or stationary platform that contains the generator station. A continuous loop of main line may be used in this embodiment.

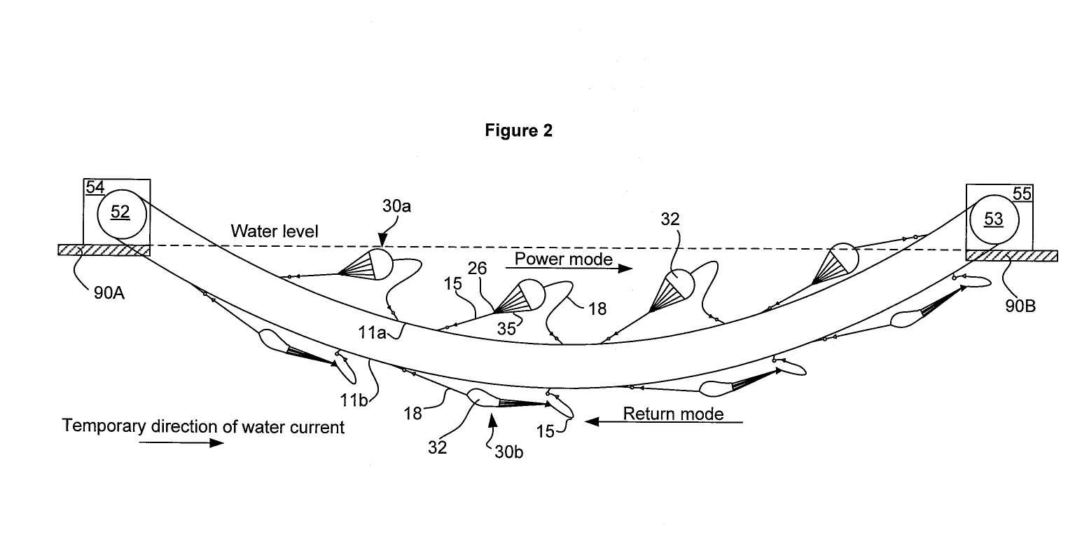

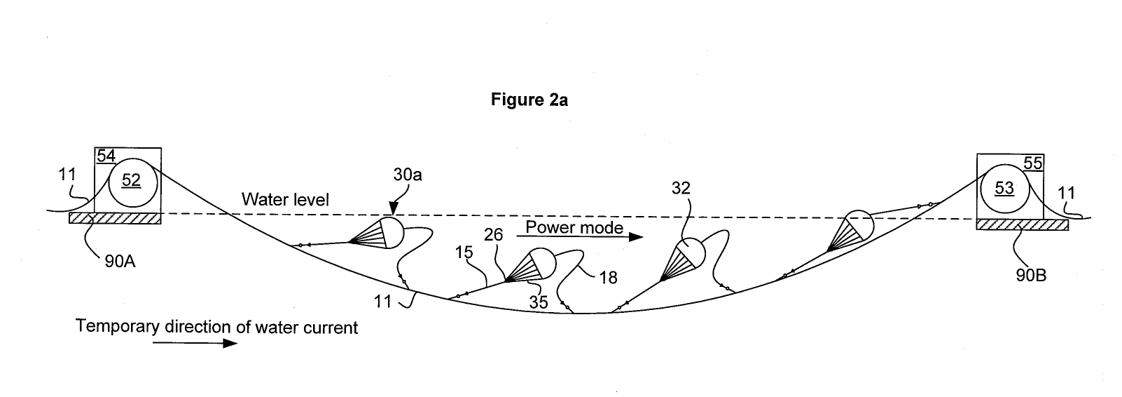

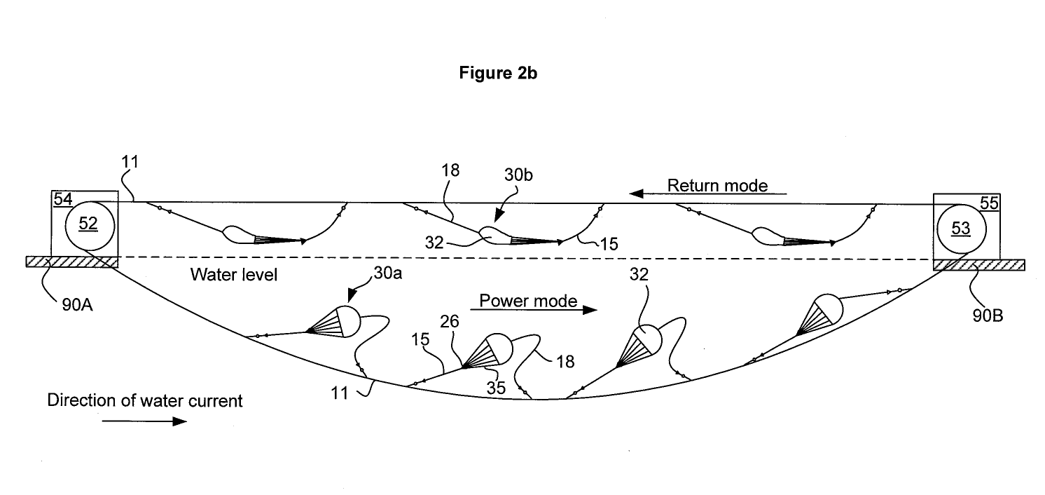

FIG. 2 shows a second embodiment of the present invention in which a continuous length of main line 11 with sea anchors 30 may be deployed from two separate locations depending on the direction of the current flow. In power mode, the sea anchors 30 are pulled by the moving tidal current. The expanded sea anchors 30a exert force on the main line 11 and pull it to and/or from rotating bodies 52 and 53. Depending on the direction of the water current, either rotating body 52 or 53 may drive generators 54 or 55 to make electricity. It should be understood that rotating body 52 may drive generator 54 at the same time that rotating body 53 drives generator 55 such that both generators 54 and 55 produce electricity or other form of useful work simultaneously.

In the embodiment shown in FIG. 2, the two-point system (e.g., a two-shoreline system) may use a main line 11 adapted to run both in power mode and in return mode, but with only one generator station located at either point 90A or 90B. Such a system may use a rotating device 53 such as a drum, block, open-end pinch sheave block, or pulley-type device at the downstream shoreline 90B. With this type of system only one shoreline generator station may produce electricity, while the downstream shoreline would be primarily used for rerouting the main line 11 back to the generator station located at 90A. The downstream shoreline may be equipped, for example, with a device—shown as rotating body 53—such as an open-end pinch sheave block which would not require the sea anchors 30, leader lines 15, or trip lines 18 to be removed at the downstream non-generator station located at 90B. The sea anchors may be removed when they reach the generator station located at 90A in return mode and subsequently reattached to the main line in power mode 11a. The downstream, or non-generator station—located at point 90B—may be placed at a location that does not require electricity, such as a remote island. This setup may be adapted to work both in flooding as well as ebbing conditions.

The direction of the river or tidal current will determine the direction of travel of the main line in power mode 11a and that of the expanded sea anchors 30a. The direction of the flow current will also determine which generator—either 54 or 55—produces electricity. The length of main line 11—and the number of sea anchors 30—needed in the embodiment shown in FIG. 2 may be determined from the speed of the tide or river current and the length between the two generator facilities.

A variation of the embodiment shown in FIG. 2 is depicted in FIG. 2a. In FIG. 2a, the main line 11 may be deployed from one deployment point 90A (e.g., a shore) and retrieved at another point 90B (e.g., a second shore) downstream of the tidal flow. The sea anchors 30 may be retrieved in most cases and then arranged to be deployed when the tidal flow reverses its direction. The main line 11 may be adapted to drive a generator from either point 90A or 90B, depending on the flow direction of the tide.

In the embodiment of the invention shown in FIG. 2a, leader lines 15 and trip lines 18 may be disconnected from the main line 11 as they reach point 90B. Sea anchors 30 may be stored along with the trip lines 18 and leader lines 15 until they are reconnected to the main line 11 when a tidal flow changes direction, for example. In some instances, rotating bodies 52 and 53 may be of the same type. In some other instances, rotating bodies 52 and 53 may be of different type. In some instances, a separate retrieval system may be needed to retrieve the system components—including, the main line 11, the trip lines 18, the sea anchors 30, and the leader lines 15—as they reach point 90B. In yet some other instances, a smaller rotating body—such as a drum, pinch sheave or capstan—than the one used to rotate electrical generators 54 or 55 may be used for retrieval of the main line 11 and the other components in return mode, e.g., sea anchors 30, trip lines 18, and leader lines 15. The appropriate retrieval system may be adapted to fit the requirements of the site in which it is installed.

The embodiment of the invention shown in FIGS. 2 and 2a may be set up in various ways to take advantage of river or tidal currents, for example. The sea anchors 30 may be attached to the main line 11 by means of a tether line (not shown), which itself attaches to the shroud lines 35 of the sea anchors. The tidal or river current, for example, may fill the underbelly of the canopy of the sea anchor and cause it to pull upon the main line 11. This movement causes rotating body 52 to rotate and drive generator 54. When the current changes direction in an embodiment such as the one shown in FIG. 2a, the movement of the main line 11 will be reversed and rotating body 53 will rotate and drive generator 55 to produce electricity or other form of useful work. When the current changes direction in an embodiment such as the one shown in FIG. 2, the system may be adapted such that the movement of the main line 11 remains in the same direction as that present before the water current reversed direction.

Referring again to FIG. 2, when the leader lines 15 are in power mode, they are in a state of tension. The trip lines 18 will generally be in a slack state when in power mode. The opposite is generally true in return mode. When in return mode, the trip lines 18 will be in tension while the leader lines 15 will generally be in a slack state. The tension in trip lines 18 in return mode assists in the collapse (or deflation) of the sea anchors in return mode 30b.

In the embodiment shown in FIG. 2a, when the trip lines 18 reach point 90B, they may be safely retrieved along with the sea anchors 30 and leader lines 15 and stored at point 90B until the tide changes direction. The main line 11 may be stored in a manner that will enable the main line to be deployed from point 90B, and routed through rotating body 53 which may drive electrical generator 55. This will occur once the tidal current has reversed itself and is moving in the direction opposite to that shown in FIG. 2a.

The embodiment of the invention shown in FIG. 2a may be used in many different tidal power sites. Initial capital investment for the main line 11, the sea anchors 30 and the two separate power-operating facilities at points 90A and 90B may be greater than that for other embodiments disclosed herein. While this initial investment may be of some concern to a power site owner, the embodiment shown in FIG. 2a may provide the greatest return on investment, in particular because this concept may have the greatest potential for electric power production. By way of illustration, determination of the length of the main line 11 and the number of sea anchors 30 needed to make this concept work best may be accomplished as follows. The main line 11 length may be determined by the speed at which the tidal current is moving at a given site. If, for example, the tidal current has a speed of 10 miles per hour for 6 hours and a length between points 90A and 90B is 6 miles, then a minimum of 66 miles of main line 11 will be needed. If a safety factor of 25% of main line is allowed, then the length of main line 11 will be approximately 82.5 miles. If sea anchors are attached to the main line 11 every 1000 feet, then approximately 350 sea anchors 30 will be needed. In general, the more sea anchors 30 attached to the main line 11, the greater the power that will be exerted on the main line 11, by the sea anchors 30 due to the speed of the water current. The linear force exerted by the sea anchors on the main line 11, is also dependent on the diameter of the sea anchors 30. Smaller sea anchors may be easier to handle when being deployed or retrieved; however, smaller sea anchors will also have a smaller surface area, which may generally exert less force than larger anchors on the main line 11. If smaller diameter sea anchors 30 are attached to the main line 11, then it may be necessary to increase the number of sea anchors 30 attached to the main line 11. This may be necessary to develop a given amount of force that will be transferred to either rotating body 52 or rotating body 53, depending on the direction of the current flow. Additionally, the maximum diameter of sea anchors used may well be defined by the depth of the water body in which the system is placed. A sea anchor diameter that is too large may interfere with the sea level vessel traffic and/or wind waves, debris, or weather-related conditions present at or near sea level. Additionally, a sea anchor diameter that is too large may cause the sea anchors 30 to drag on the bottom of the sea floor and may cause damage to the sea anchors 30 and or main line 11. Yet another factor that requires consideration is the site location for retrieval of the sea anchor, as the diameter of a sea anchor may affect the ease and safety with which a system may be retrieved. Retrieval of a sea anchor may be accomplished in the back eddy of a tidal body. This may aid retrieval of sea anchors 30 and main line 11 with less tension on either component. Yet another consideration may be to achieve and appropriate balance between the linear force exerted on the main line and the speed of the main line. Each should be strategically used to maximize the power—or other form of useful work—generated by the system. Systems with 100% linear force and 0% main line travel, or 100% main line travel and 0% linear force are not ideal. A workable and efficient combination of both is desired.

Vessel and shipping traffic conditions found in a given tidal power site may need to be taken into consideration when designing a tidal power system. The sea anchors 30 and the main line 11 should be at a depth that prevents them from becoming a navigational hazard to ships or other vessels. This may be accomplished by strategically placing weights on a floating main line, or by placing floats on a sinking main line. This will require determination of whether a floating or a sinking main line may work best for a particular tidal power site. Floats or weights (not shown) may also be placed on the canopy 32, leader lines 15 or trip lines 18 of the sea anchor 30 to control the depth at which the sea anchor 30 will travel. In some very unique cases, a heavy steel wire rope may need to be used as a guide for the main line to travel. Heavy steel wire rope may lie between points 90A and 90B. This steel wire rope may lay deep enough in an arc so as to avoid vessel and/or shipping traffic. The steel wire rope may have a pulley (not shown) attached. The pulley may be equipped with a tether that may connect to the main line 11 at equally spaced increments. The pulley may guide the main line 11 and sea anchors 30 in a direction and depth that would be consistent and predictable. Such a pulley may be used to control the depth and direction of the main line 11 and sea anchors 30 in an otherwise unpredictable area of control. In a unique case such as that found in the Gulf Stream off the East Coast of the United States—where the tidal current only moves in one given direction at all times—a very long length of main line 11 in power mode capable of traveling for hundreds of miles may be used. The curvature of the Earth may aid in maintaining the main line 11 and sea anchors 30 well below the vessel and shipping traffic found at sea level.

When retrieving the main line 11 and the sea anchors 30 in the embodiment shown in FIG. 2a, it may be advantageous to let the main line 11 and sea anchors 30 be routed through the back eddy of the tidal current. This may necessitate that less tension be placed on the main line 11 and the trip line 18 as point 90B is approached. The manner of retrieval of the main line 11 and the sea anchors 30 may also affect the depth at which the main line 11 and sea anchors 30 tend to travel. If the main line 11 is being retrieved with a large amount of tension on the main line and the trip lines, then the system may develop a tendency to raise the main line 11 and the sea anchors 30 from their correct traveling depth.

In a two-point system, such as the one shown in FIG. 2a—i.e., a two-shoreline system—two generators may be used, one located at each station. In such a case, the main line 11 may not run in a continuous loop but rather it may run between the two generator stations in a power mode. At any given time, the main line 11 shown in FIG. 2a runs in one direction only. The sea anchors 30 attached to the main line 11 are in a power mode state. Once the main line 11 and sea anchors 30 reach point 90B, which may be—for example—a second shoreline station, they may be stockpiled and stored. When the tidal direction or tidal flow changes direction, the main line 11 and sea anchors 30 move in the new direction of the current. Once they reach the generator station, the main line 11 and sea anchors 30 may be stockpiled and stored. This can occur repeatedly depending on the direction of the tidal current. This system may be somewhat more expensive than other setups disclosed herein because it may require a longer length of main line 11. The length of main line 11 is dependent on the distance between points 90A and 90B, which may be, for example, two shorelines. Other costs may be incurred with this setup because of the number of sea anchors 30 that may be needed. The number of sea anchors used may depend on the speed of the tidal flow or current, and on the spacing between the sea anchors 30. One of the benefits of this setup is that efficiency may increase because there is no drag from sea anchors 30 in return mode. The help of a retrieval winch or retrieval hauler for stockpiling and storing the main line 11 and sea anchors 30 may be necessary when the main line 11 in power mode and the sea anchors in power mode 30a reach the downstream point 90B, which may be a shoreline generator station. In a two shoreline system, such as the one shown in FIG. 2, the main line 11 and sea anchors 30 may be run in power mode and in return mode. Either one of the stations, or both stations, may be equipped with generators to produce electricity.

For bodies of water with no current reversal—for example, rivers—and in particular bodies of water where it may not be feasible to maintain the main line in return mode underwater, an embodiment such as the one shown in FIG. 2b may be used. FIG. 2b shows a two-point system where the main line 11 runs in a continuous loop between points 90A and 90B. The sea anchors 30 may be deployed from point 90A. In power mode, the sea anchors 30 are pulled by the moving current. The expanded sea anchors 30a exert force on the main line 11 and pull it from rotating body 52 toward rotating body 53. Rotating body 52 may drive generator 54 and rotating body 53 may optionally drive generator 55.

In the embodiment shown in FIG. 2b, the main line 11 in power mode moves underwater while the main line 11 in return mode moves above water. The system shown in FIG. 2b may use various types of rotating bodies 52 and 53 such as, for example, drums, pinch sheaves, bullwheels or capstans. The rotating body 53 may be an open-end pinch sheave block adapted such that sea anchors 30 need not be detached from the main line 11 when they reach location 90B and are rerouted to location 90A. Additionally, the sea anchors may be detached from the main line 11 when they reach the generator station located at 90A in return mode and subsequently reattached to the main line 11 when they are deployed in power mode.

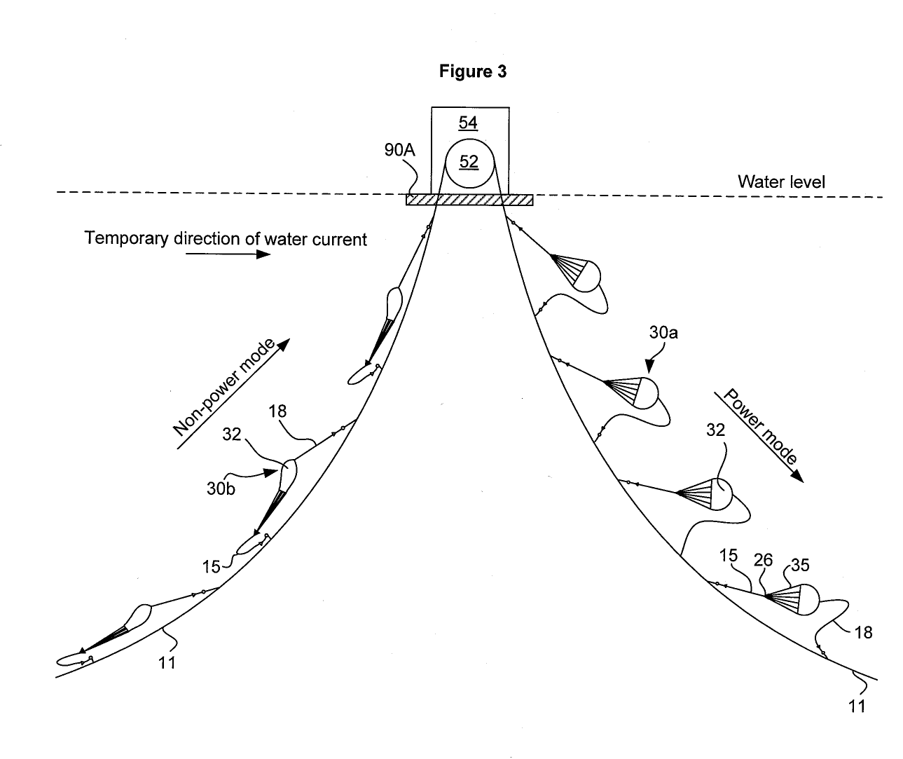

Yet another embodiment of the present invention may be the system shown in FIG. 3. This embodiment has a continuous length of main line 11 that is not in a continuous loop. There is only one rotating body 52—which may be a drum, pinch sheave, bullwheel or capstan—through which the main line 11 may be routed such that rotating body 52 rotates to produce electricity or other form of useful work. The direction of the tidal current will determine which sea anchors 30 are in power mode and which sea anchors 30 are in a non-power mode. In this embodiment, the sea anchors 30 and main line 11 in power mode are allowed to drift until the tidal current reverses direction. While this is taking place the non-power mode sea anchors are returning to the generator facility, located at point 90A, and may be deployed as sea anchors in power mode. This type of embodiment may require a very large area for the main line 11 and sea anchors 30 to either obtain neutral buoyancy below sea level or to drift such that they do not interfere with vessel navigation.

The embodiment shown in FIG. 3 is in some ways similar to the embodiment shown in FIG. 2a. One difference between these two embodiments is that in the embodiment of FIG. 3, only one deployment point 90A (e.g., a shoreline) is used and the sea anchors 30 pull the main line 11 through rotating device 52, which may be a drum, pinch sheave, bullwheel, or capstan that produces electricity by driving generator 54. The sea anchors in power mode 30a are allowed to travel into the tidal stream where they may drift until the reversing tidal movement returns them to, for example, a shoreline located at point 90A. The main line 11 and sea anchors 30 may then be deployed in the opposite direction and allowed to drift until they can repeat the process in the opposite direction.

The embodiment shown in FIG. 3 may be used less than other concepts disclosed herein. This is the case because the natural conditions apt for this concept are less likely to be found in nature. The embodiment shown in FIG. 3 uses a single shoreline deployed in the middle of a large tidal current body. This point of deployment may be an island or perhaps a cape, or maybe a point that extends from a landmass. This embodiment uses a continuous length of main line 11 that is retrieved in either direction and which may be placed into the water after going through a drum, pinch sheave, bullwheel or capstan driving an electrical generator 54. Point 90A, which may be a single shoreline, may house a rotating device 52—such as a drum, pinch sheave, bullwheel, or capstan—for driving electrical generator 54. The direction of the tidal current will determine on which end of the rotating body, the main line in power mode will be placed. The sea anchors in power mode 30a are allowed to pull the main line 11 in power mode as long as the tidal current is pushing them in a particular direction. On the opposite end of rotating body 52, the sea anchors are in a non-power mode drift. This concept may require ample room for the main line 11 and sea anchors 30 to either pull or drift.

The system shown in FIG. 3 uses a single generation station, which may be strategically located in a place where there is current reversal, for example, an island located in a tidal flow area. The stationary location may also be an anchored vessel, or an oil rig attached to the sea floor, for example. A continuous length of main line 11 may be routed through a single generator station located at point 90A. The generator station may have a retrieval winch or a retrieval hauler located on either side of the single generator station. For an embodiment such as that shown in FIG. 3, a retrieval winch or retrieval hauler may be important under some circumstances. For example, the sea anchors in power mode and the main line in power mode may move at a speed that is less than the speed of the tide or current. This may be necessary in order to build linear force from the moving tide or water current. As a result, the returning sea anchors and the returning main line in a non-power mode drift may be returning to point 90A faster than the sea anchors in power mode and the main line in power mode are being deployed from point 90A. A retrieval winch or retrieval hauler may enable easier handling of the sea anchors and main line that are in a non-power mode drift and returning to the single generator station. The main line 11 may be pulled through the single generator station by the sea anchors in power mode when the tidal flow or current is ebbing. The sea anchors 30 may be attached to the main line 11 in power mode as the main line 11 drifts away from the generator station. Once the tidal flow or current stops ebbing and begins its flooding phase, the sea anchors 30 may be detached from the main line 11 that is pulled in the ebbing direction. The sea anchors 30 may then be detached at the generator station as the flooding tidal current or tidal flow returns them to the generator station along with the main line 11. As this happens the main line 11 in power mode travels away from the generator station in the flooding direction. The sea anchors 30 may be detached during the ebbing tidal flow or tidal current. The sea anchors 30 may be reattached to the main line 11 which may now be pulled by the flooding tidal flow or tidal current away from the generator station in the flooding direction. The generator located at point 90A may be engineered to produce electricity when rotating body 52 rotates either clockwise or counterclockwise. The main line 11 may be rerouted through the rotating body 52 at a time when the main line may be slack as determined by the tidal flow or tidal current.

It is expected that the embodiments of the present invention shown in FIGS. 1, 2, 2a, and 2b may be the most common in practical applications due to the more common natural conditions apt for these systems vis-à-vis the embodiment shown in FIG. 3. The dimensions of a tidal power site may likely define the overall main line 11 length and number of sea anchors 30 used in the embodiments shown in FIGS. 1 and 2. The overall main line 11 length and number of sea anchors 30 used in the embodiment shown in FIG. 3 will likely be determined by the strength, speed, and/or direction of the tidal current relative to the point of deployment. In general, the greater the combined surface area of sea anchors—which depends on both the number and diameter of sea anchors used—exposed to a tidal current, the greater the electric power that will be produced at a particular site. An important design consideration regarding the main line is that it should be engineered to withstand large pulling forces. The tensile strength of the main line, trip lines, and leader lines is an important design criterion. Also important is properly selecting the diameter of the rotating body in relation to the main line as this may prevent premature wear and damage to the main line and—in extreme cases—a break in the main line.

In general, the greater the linear force exerted on the main line, the greater the power to be produced by the rotational force of the rotating body—whether a drum, pinch sheave, bullwheel, or capstan. It may be advantageous when installing a tidal power site, to test with a dynamometer, which may be attached to the rotating body, the exact amount of power that may be produced by a particular tidal power site.

In some situations it may be an advantage to use sea anchor shapes that are not the more common round-type. Although round sea anchors are most common—and can be manufactured in many different diameters—in some cases, it may be advantageous to use a rectangle shape sea anchor that is built to suit shallow depths. For example, in a tidal or river site that is 50 feet deep by 500 feet wide, instead of using a round sea anchor with a diameter of 40 feet, it may be preferable to use a rectangular sea anchor that is 40 feet deep by 200 feet wide. This type of rectangular sea anchor may require more than a single main line. Instead, multiple main lines may be used, for example, one main line for each corner of a rectangular sea anchor. Rectangular sea anchors may use head ropes and foot ropes. A head rope defines the upper portion of the rectangular sea anchor, while the foot rope defines the bottom portion of the rectangular sea anchor. A main line may be used every 50 feet along the horizontal head rope and foot rope of the rectangular sea anchor.

A power site equipped with rectangular sea anchors, may use multiple drum winches, traction winches, powered pinch sheave blocks, bullwheels or capstans (engineered to produce electricity—rather than to be powered by electricity). When in power mode, quick disconnects may be locked into position by stops placed on the main lines. These quick disconnects may attach to a locking-enclosed hook that can be placed around the main line and allowed to slide on the main line. When in power mode, the locking enclosed hook, which can also be used as a quick disconnect, may be pushed up against a predetermined stop on the main line that aligns the rectangular sea anchor to take advantage of the full force of the moving water such that the sea anchor reaches its maximum drag potential. When in return mode, the locking-enclosed hook may be allowed to slide on the main line and be pushed up against a predetermined stop on the main line that aligns the rectangular sea anchor to take advantage of the least force of the moving water while the rectangular sea anchor is in return mode. An embodiment using sea anchors of rectangular shape may be used in a single shoreline system with river or tidal currents that flow in one direction.

Rectangular sea anchors with multiple main lines may also be used in the second embodiment of the present invention shown in FIG. 2a, where sea anchors are used in a two-shoreline system with drum winches, traction winches, pinch sheave blocks, bullwheels, or capstans on both shorelines. In this system, the multiple main lines travel in one direction from one shoreline to the other. When the rectangular sea anchors reach the second shoreline, they may be stock piled, until the tidal current changes direction. The sea anchors may then travel in the opposite direction to the opposite shoreline. In this embodiment, the multiple main lines and the rectangular sea anchors may be stockpiled after they have completed their power mode at the downstream tidal current shoreline location until the tidal direction changes and they are deployed to travel in power mode back to the opposite shoreline.

In yet another embodiment of the present invention, rectangular sea anchors may be used with a single main line. These rectangular sea anchors may use similar trip lines and leader lines as round sea anchors. The rectangular sea anchors may also use weights, floats, quick releases, swivels, etc., as those described in previous embodiments. One advantage of a rectangular sea anchor is that its large surface area may be used to generate significant force from the river or tidal current, particularly in shallow water applications.

For the embodiments disclosed herein—such as the single-point deployment systems shown in FIGS. 1 and 3, or the two-point deployment system shown in FIGS. 2, 2a, and 2b—the sea anchors, leader lines, and trip lines may be adapted to be connected and disconnected with ease from the main line. The systems may use hardware connections, tethers, or knots. The locations on the main line where the trip lines, leader lines (also called sea anchor lines) are to be connected may be pre-marked on the main line.

In most cases, the embodiments described herein may need to take into account the need to stay clear of ships and vessels and to not cause a navigational hazard. This may be accomplished by adding weights and/or floats to the main line and to the sea anchors, as necessary. Floating radar reflectors, buoys, radio signal transmitters and/or lights may also be attached to the sea anchors and or main line to aid in heavily navigated areas. In some instances, such as in a project that may be located in the Gulf Stream from Cuba to the U.S.-Canadian border, the very long length of main line and sea anchors, may take advantage of the curvature of the Earth to travel well below sea level.

In embodiments of the present invention where the main line and the sea anchors move from below sea level to above sea level, the effects of the sea anchors and the main line may be carefully monitored. If there are any adverse effects on the environment, the entire system may be removed within a few hours, leaving no environmental footprint. To minimize the impact on sea life migration, the system may use fewer sea anchors, sea anchors with smaller diameters, or the entire system may be removed with great ease during the migration seasons.

A retrieval winch or retrieval hauler may be used to retrieve the main line and the attached sea anchors in an emergency shutdown or a maintenance situation that may require the main line to be brought ashore along with the attached sea anchors. This retrieval winch may also be used to maintain a certain amount of tension on the main line in return mode as it enters the drum winch, pinch sheave, traction winch, bullwheel, or capstan. The retrieval winch or retrieval hauler should be capable of retrieving the main line at a speed that exceeds the speed of the main line in power mode and in return mode. This enables the drum winch, pinch sheave, traction winch, or capstan to continue to rotate while the main line in return mode is being retrieved at a faster rate by the retrieval winch or retrieval hauler. The retrieval winch or retrieval hauler may generally be mounted in the area where the main line in return mode is normally routed back to the drum winch, pinch sheave, traction winch, bullwheel, or capstan. For example, if the main line were to part or break at a location where the main line is in power mode, then the main line would generally be retrieved with the retrieval winch or retrieval hauler. The same would be true if the main line were to part or break at a location in return mode. Normal retrieval direction would be to pull in the main line in return mode simply because the sea anchors are in a collapsed condition and are much easier to retrieve. Fully open sea anchors in power mode may be difficult to retrieve if such retrieval is attempted in a direction opposite the tidal current, for example. Such a retrieval may very well cause the weak link to part or break from the leader line. But, if the main line in power mode—with fully open sea anchors—is retrieved in the down current or tidal current direction and the retrieval winch or retrieval hauler operates at a speed that is faster than the main line in power mode, then this would cause the fully open sea anchors to collapse, enabling the trip line to carry the tension and the leader line to go into a slack condition. This would thus allow the retrieval winch or retrieval hauler to retrieve the main line and the attached sea anchors. As an added precaution, it may be appropriate to have a retrieval winch or retrieval hauler mounted on both the power mode side of the main line and the return mode side of the main line of each drum winch, traction winch, bullwheel, or capstan that is found in a particular embodiment. If the embodiment has one drum winch, pinch sheave, traction winch, bullwheel, or capstan then there would be two retrieval winches or retrieval haulers. If the embodiment employs two drum winches, pinch sheaves, traction winches, bullwheel, or capstans then there would be four retrieval winches or retrieval haulers. The retrieval winch or retrieval hauler may also employ a clutch-like device that would allow the unit to freewheel when not in use. This may also provide a certain amount of back tension on the main line in return mode as the main line is fed back into the drum winch, pinch sheave, traction winch, bullwheel, or capstan in order to maintain a certain amount of tension and friction upon the main line as it is routed around the drum winch, pinch sheave, traction winch or capstan. A good rule of thumb for a speed of the main line through the retrieval winch or retrieval hauler is two times the speed of the main line in power mode and/or the main line in return mode, whichever is greater.

A retrieval line may be used to reroute the main line across a body of water to a second drum winch, pinch sheave, traction winch, bullwheel, or capstan when working with a two-drum winch—two-pinch sheave—two-traction winch—two-bullwheel or two-capstan—system, with one on each shoreline. The retrieval line may be pre-routed and may lay at the bottom of the body of water extending from a first shore to a second shore. The distance between shores would be approximately equal to about half the length of the main line, so the remaining length of the retrieval line, which would itself be approximately equal to the full length of the main line—plus extra length to ease handling and working—may be coiled or stored on either shore. This retrieval line would be available for use in a situation where the main line parted or suffered a break and needed to be rerouted across the body of water and through the drum winches, pinch sheaves, traction winches, bullwheels, or capstans. When used to remove the main line from the body of water, a retrieval line may be easily attached to one end of the main line while it is being removed, allowing it to follow the same route as that of the main line. This feature may ease the installation of the main line when it is ready to be reinstalled, eliminating the need for a vessel or boat to route the main line back and forth between the shorelines and the drum winch, pinch sheave, traction winch, bullwheel, or capstan.

A cleat or bollard may be located near the retrieval winch or retrieval hauler. There may be at least two cleats or bollards for every retrieval winch or retrieval hauler. The cleat or bollard is used to secure and tie off main lines in return mode, main lines in power mode, or retrieval lines, when maintenance is being done on the drum winch, pinch sheave, traction winch, bullwheel, capstan, retrieval winch or retrieval hauler. These cleats or bollards are useful in working with lines or ropes that may have tension on them.

The main line in return mode or power mode—or the whole main line as a unit—may be manufactured to float or sink to varying degrees based on the specific gravity or density of the body of water where it is placed. Generally, the site in which it is placed would determine if it is advantageous to have a floating or a sinking main line. If a sinking main line with uniform weight throughout its length is required, then a wire rope main line may be chosen over a high strength synthetic rope main line. Additionally, removable main line weights and/or removable main line floats may be used to meet specific buoyancy needs. A sinking main line may be an advantage when working in areas of high vessel traffic and or shipping lanes and where the depths of the body of water allow for the main line to run deep. In shallow areas it may be an advantage to work with a main line that is generally buoyant or floating.

Sea anchors may also have sea anchor weights and/or sea anchor floats attached to them. These weights and/or floats may be temporarily attached or permanently attached. These weights or floats may prevent the sea anchors from twisting around the main line in either power mode or in return mode. These weights or floats may also enable the sea anchor to ride above or below the main line in either power mode or return mode with more ease. A neutral buoyancy bulbous float may also be used between the trip line and the canopy of the sea anchor, and may be placed at the location where the trip line is connected to the canopy of the sea anchor. This neutral buoyancy bulbous float may act generally as a bulbous bow when the sea anchor is in return mode and the canopy is collapsed. The bulbous bow effect may serve to decrease the drag associated with the sea anchor in a collapsed condition. The size of the neutral buoyancy bulbous float will depend upon the size of the sea anchor in use.

The sea anchors may also have sea anchor chafing gear. This chafing gear may be used to prevent the main line (in either power mode or return mode), the trip line, and/or the leader line from damaging the canopy or any other part of the sea anchor. The sea anchor chafing gear may be primarily utilized on the outer diameter of the sea anchor canopy when open or collapsed. The periphery of the canopy may be an area where the main line in power mode, the main line in return mode, the trip line, and/or the leader line may have a tendency to rub against the sea anchor while in power mode and/or in return mode. Chafing gear is essentially a material or substance that sacrifices itself, or takes the wear and tear rather than the material or substance that it protects. Chafing gear may be manufactured from any material that is light weight, does not hold or absorb water, is easy to attach and detach, and is tough and wear resistant. Various types of pieces of ropes and lines are used as chafing gear in the commercial fishing industry to help protect netting that might drag along a rough and rocky sea floor. Such chafing gear may also be used in the present invention.

For some river or tidal hydrokinetic site applications, certain embodiments of the present invention may not allow for retrieval and/or stock piling of the sea anchors as they reach the end of their return mode cycle and/or power mode cycle. In such cases, it may be important to determine with precision the lengths of trip lines and leader lines such that the sea anchors remain in the water at all times, unless it is necessary to bring them ashore—or to the stern of the vessel—for maintenance or inspection. For example, if the drum winch, traction winch, capstan, bullwheel, or powered pinch sheave block (converted to produce electricity rather than to use electricity) is located 100 feet from the water, and if the trip lines and leader lines are being detached and reattached to the main line 20 feet in front of the drum winch, traction winch, powered pinch sheave block, bullwheel, or capstan, then trip lines and leader lines of 80 feet in length are needed. If in this example, a powered pinch sheave block is used, then it may not be necessary to detach and reattach the trip lines or leader lines. In such a case, 100-foot trip lines and leader lines will be needed. In addition, the length of trip lines and leader lines should be sufficient to maintain the sea anchors in power mode fully open and away from the main line such that the canopies do not rub or chafe against the main line. In return mode, the trip line is the first part that emerges from the water. The trip line may be detached at the quick disconnect and in the same motion it may be reattached to the main line in power mode with the quick disconnect. At this point, the trip line is attached and moving with the main line in power mode back out into the tidal current or river current. Soon thereafter the leader line will emerge from the water attached to the main line in return mode. The leader line may be detached from the main line in return mode and in the same motion reattached to the main line in power mode. When the trip line is detached from the main line in return mode, and reattached to the main line in power mode, the sea anchor begins to turn 180 degrees. By the time the leader line is detached and reattached, the sea anchor has completely turned 180 degrees and starts to fully expand as it begins a new cycle under power mode. It should be noted that if a pinch sheave is used, it may not be necessary to detach and reattach the trip line and the leader line. This is made possible by the fact that a pinch sheave has an open surface that allows the line to make less than one full revolution and prevents entanglement. Notably, however, quick releases may still be used on these anchors in order to ease their removal from the main line.

Predetermined spacing may be clearly marked throughout the main line in either power mode or return mode for detaching and reattaching the trip lines and the leader lines. These marks may generally coincide with the locations at which a short piece of rope or line has been spliced into the main line, and to which the chosen quick disconnect (e.g., D-link, C-link, or hook) is attached. This allows the leader lines and the trip lines to maintain a proper distance with respect to one another.

For systems where a two-shoreline embodiment is used, and, the body of water between the two shorelines is a high shipping traffic or vessel traffic area, underwater anchor guides located near each shoreline may be used at the locations where the main line enters or exits the water. These guides may also be a single pile or a gravity anchor. If the body of water is deep enough to allow the sea anchors to run at depths below that of the shipping traffic and vessel traffic then such a depth can be easily determined. Once the proper depth has been determined, the anchor guide may be positioned at the proper depth. The anchor guide may use a single guide hole for both the main line in power mode and the main line in return mode adapted to prevent rubbing and/or chafing. To protect the integrity of the sea anchors, these need not travel through the guide hole. Thus leaving only the main line, the trip line (with a quick disconnect), and the leader line with a quick disconnect to travel through the anchor guide. In such a case, it will be very important to have proper lengths of trip line and leader line in order to ensure that the sea anchors are not dragged through the anchor guide and damaged by the anchor guide. This would also enable an easy transition from detaching and reattaching the trip line quick disconnect and the leader line quick disconnect. Proper buoyancy will need to be maintained by the main line in power mode and the main line in return mode. The sea anchors would be adapted to maintain a chosen buoyancy in order to be clear of the sea level shipping and vessel traffic. Also a certain amount of tension will need to be maintained throughout the full length of the main line in order to prevent the main line from drifting to the surface in some situations. This tension will most likely be maintained by utilizing a proper overall length for the main line.

For some embodiments disclosed herein such as the one shown in FIG. 1, detachment and/or retrieval of sea anchors 30 in return mode as well as deployment and reattachment of the sea anchors to the main line in power mode may require a laborer. Trip lines 18 in return mode and/or sea anchors 30 in return mode may be detached from the main line 11 prior to traveling through the drum, pinch sheave, bullwheel or capstan. Trip lines 18 and sea anchors 30 may subsequently be reattached to the main line 11 in power mode once the connecting points have traveled through the drum, pinch sheave, bullwheel, or capstan. An alternative method, especially one using an open-end pinch sheave block, may also be used in which the trip lines 18 in return mode, the sea anchors 30 in return mode, and the leader lines 15 in return mode may remain connected to the main line 11 and guided through the drum, pinch sheave or capstan until once again they become trip lines 18 in power mode and sea anchors 30 in power mode. Regardless of the method used at a particular site, the use of a laborer to oversee the project components at work may be advisable. A renewable energy job is a plus for a nation's economy and a tidal power project that is under constant monitoring and supervision is better suited to gauge all aspects of the environmental impact and efficiencies of the system.

It is to be understood that all embodiments disclosed herein may be used under ebbing or flooding tidal current or one-direction river current. Additionally, power plants that are used in a wind turbine or a wind power plant are easily adaptable to embodiments of the present invention due to the relatively low rotational speed and high torque for which they are engineered. A rotational body such as a drum, or pinch sheave may be mounted to the shaft on which the hub of a wind turbine may have been previously mounted. A gearbox may be used to increase the rotational speed of such a turbine such that the generator is rotated to produce electricity. An annular multi-pole-type generator may also be used.

The embodiments of the tidal power system presented herein may be used with systems that clean up electricity in order to prepare it for an electric grid. It will also be understood by someone skilled in the art that the power generated by the embodiments of the present invention may be used off grid, on grid, offshore, or onshore. The system disclosed herein may operate in very rough seas and extreme weather conditions.

The embodiments of the present invention may also be adapted to operate fully underwater with submerged generators and pinch sheave-type drives mounted to large gravity anchors or monopole-type caissons. For a system that is completely submerged, it may be necessary to operate with a pinch sheave-type rotational body to drive the generators or a less than a full revolution-type device.

In some situations, a bridge or single shoreline may be used in place of a caisson. The generator station attached to the bridge could be above or below the water. It is normally beneficial to have the generator station above water. Systems for which the generators are placed above the water are generally called “soft hydrokinetic systems,” whereas those that are submerged may be described as “hard hydrokinetic systems.” If, for example, one of the generator stations is placed on a bridge, a second generator station may be placed in a caisson or monopole located within the tidal current or river current—such a generator station may be above or below the water. It will also be understood by someone skilled in the art that an embodiment of the invention disclosed herein may use a bridge as the location for one generator station and a shoreline located downstream of the tidal current or river current as a second generator station. Additionally, a boat, vessel, or barge may be used as the second generator station. Some embodiments of the present invention may simply use a second generator station to reroute the main line and the sea anchors to the first generator station. Additionally, some embodiments may use a one-point of deployment system. Systems using a single shoreline may be combined with a boat, vessel or barge located off the shoreline either as a generator station or simply as a means to reroute the main line and the sea anchors. Two boats, vessels or barges anchored within a tidal current or river current may also be used.

Some embodiments of the invention described herein may operate with the main line in power mode and return mode, or only in power mode. Similarly, the sea anchors may operate in power mode and return mode, or only in power mode. For systems operating only in power mode in bodies of water with non-reversing flows, it may be necessary to adapt means to transport the main line and the sea anchors upstream to the original starting point.

In yet other embodiments of the invention, main lines may be redirected from the original starting point into different directions by using roller guides or open-end pinch-sheave-type pulleys or snatch blocks. The redirecting of the main lines may take place horizontally or vertically. Vertical redirection of main lines may be achieved, for example, if the generator station is located atop a monopole caisson or a bridge and the main lines are allowed to travel vertically, below sea level, and where the generator station is located above sea level. Such a system may be used if the goal is to maintain the main lines and sea anchors below the shipping lanes and sea level shipping and vessel traffic, while keeping the generator station above the sea level in a soft hydrokinetic system. This is akin to the use of anchors disclosed in embodiments of the present invention located on shorelines.

The main lines and sea anchors of the embodiments disclosed herein may also be used in fully enclosed or partially open pipes, tunnels, channels, canals or any type of manmade conveyance system for freshwater, saltwater, raw sewage or treated sewage waters. The embodiments of the invention may be used with virtually any type of liquid conveyance system. Additionally, the sea anchor canopy may be used to display visual advertising of various sorts.

For round or rectangular sea anchors, means other than sea anchor canopy floats and/or sea anchor canopy weights may be used to maintain a sea anchor in proper alignment relative to the main line in power mode. Sea anchors may be aligned—relative to the main line axis—at 0, 90, 180, or 270 degrees, or any other desired angle. This may be accomplished by biasing the canopy of the sea anchor in a desired direction relative to the main line in power mode. If, for example it is desired that the sea anchor in power mode travel at a zero-degree angle relative to the main line, then increasing the surface area of the sea anchor canopy in the range of −90 to 90 degrees may accomplish the desired biasing. Surface area biasing of the sea anchor canopies may be used in combination with weights or floats to accomplish the desired alignment of the sea anchors relative to the main line. Biasing the relative alignment of the sea anchors may also be accomplished by adjusting the length of the shroud lines, alone, or in combination with the methods previously described.

The alignment of the sea anchors relative to the main line may be affected by factors such as the length of the trip lines, the length of the leader lines, the use—or non-use—of floatation or weight devices, the speed and power of the tidal or river current, the speed at which the main line in power mode is allowed to move, and/or the position and route of the main line in power mode relative to the direction and route of the tidal or river current, among others. It would be understood by someone skilled in the art, that proper alignment of the sea anchors may be desired to prevent chafing of the main line in power mode or return mode, chafing of the sea anchor in power mode or return mode, twisting and/or tangling of the sea anchors and main line.

Some of the soft hydrokinetic systems contemplated in the present invention may use various types of pliable sheet material, which may be synthetic or non-synthetic, for example. These materials may be generally capable of collapsing underwater. Examples of materials that can be used in the manufacture of these pliable sheets include those known under the trade names of Kevlar, Zylon, Dacron, Dyneema, Technora, Twaron, Vectran, and Spectra fiber. Nylon and polypropylene can also be used, among others. Certain embodiments contemplated in the present invention may use a long sheet of pliable material that is rolled around a drive axle. One end of the sheet material may be operatively secured to the drive axle while the other end of the sheet material may be deployed underwater in the presence of a current. The sheet material may be adapted to unroll from the drive axle as it is dragged and/or pushed by the water current. As the sheet is unrolled, the drive axle may be adapted to rotate and to drive a generator that produces electricity. The drive axle may be placed vertically or horizontally at a shoreline or other point of deployment. Additionally, the axle may generally have a longitudinal length that is longer than the width of the long pliable sheet adapted to be rolled and unrolled from—and onto—it.

In some embodiments contemplated herein, multiple drive axles may be placed at a point of deployment. The multiple drive axles may be used to drive planetary gears. Each axle may be adapted to drive a corresponding generator or each axle may be adapted to assist in driving a common generator. Drive axles may be adapted to achieve continuous operation and rotation of a generator, and may also be adapted to rewind unwound sheet material onto a corresponding drive axle. In such systems, the end of the sheet material exposed to the water current may be operatively secured to a cross stream object. As the sheet material nears the end of its roll, the end of the sheet material—operatively secured to a cross stream object—may be released and allowed to drift. Once released from the cross stream object, the low drag exerted by the water current onto the sheet material makes it easier to rewind the sheet material onto the drive axle. As a matter of convention, a rotating drive axle from which sheet material is being pulled off—by the flow of the current—may be referred to as a “drive axle in power mode,” while a drive axle with sheet material being rewound onto it may be referred to as a “drive axle in return mode.” Rotation of a drive axle once the sheet material is completely unwound may be achieved by operatively coupling the drive axle to a second drive axle operating in power mode. Under such circumstances, the unrolled sheet material may be rewound onto the bare drive axle. Such a continuous operation may be achieved by adapting at least two drive axles in a way that allows one to operate in power mode while the other operates in return mode.

The soft hydrokinetic systems with pliable sheet material and drive axles disclosed herein may use one or more lines (e.g., synthetic ropes) for operatively attaching the cross stream end of the sheet to an object located across from the fluid current. These lines may be detached from the sheet material once the sheet material is completely unwound from the drive axle in power mode. Once the lines are detached from the completely unwound sheet material, the sheet may be rewound onto the axle. This rewinding of the axle may be achieved by operatively connecting it to an axle in power mode. Once the rewinding is complete, the lines may be subsequently rerouted and reattached to the cross stream object from which they were originally detached.

What is claimed:

1. A system for generating electric power from a fluid current comprising:
a main line;
a plurality of leader lines;
each said leader line having a proximal end and a distal end, wherein each proximal end of each leader line is operatively connected to the main line;
a plurality of drag elements, each said drag element having a current-facing surface and a current-trailing surface, wherein each said drag element is operatively connected to the distal end of a corresponding said leader line;
each said drag element adapted to resist the force of a fluid current when said current-facing surface is open to said fluid current;
a plurality of trip lines;
each trip line having a first end and a second end, wherein said first end of each said trip line is operatively connected to a corresponding current-trailing surface of a corresponding said drag element and each second end is operatively connected to the main line; and
said main line adapted to be operatively connected to at least one rotating body and one electric generator.

2. The system according to claim 1, further comprising a first rotating body in contact with said main line, wherein said first rotating body is adapted to rotate when said main line is set in motion by the fluid current.

3. The system according to claim 2, further comprising a first electric generator driven by said first rotating body.

4. The system according to claim 1, wherein each said drag element is detachable from said corresponding leader line.

5. The system according to claim 1, wherein each said drag element is detachable from said corresponding trip line.

6. The system according to claim 1, further comprising a plurality of swivel elements, each swivel element operatively connected to said main line and each said proximal end of each leader line operatively connected to a corresponding swivel element.

7. The system according to claim 1, wherein each said drag element is a sea anchor comprising a plurality of shroud lines and a flexible canopy.

8. The system according to claim 1, wherein each said drag element is adapted to expand when said current-facing surface is open to said fluid current.

9. The system according to claim 1, further comprising a plurality of weak links with a tensile strength below the tensile strength of the drag element, each weak link operatively connected to the main line and to the proximal end of a corresponding leader line, wherein said weak link breaks when it is subjected to tension above its tensile strength.

10. The system according to claim 1, wherein each said drag element is adapted to collapse when said current-trailing surface is pulled by a corresponding said trip line.

11. The system according to claim 1, wherein at least one drag element is designed with an area bias to achieve a desired alignment relative to said main line.

12. The system according to claim 2, wherein said main line is adapted to form a loop around said first rotating body.

13. The system according to claim 12, wherein said trip line is disconnected from the main line as said trip line approaches said first rotating body.

14. The system according to claim 12, wherein the leader line is disconnected from the main line as said leader line approaches said first rotating body.

15. The system according to claim 2, wherein said first rotating body is adapted to pivot in a direction of said fluid current if said fluid current changes direction.

16. The system according to claim 2, further comprising a second rotating body located downstream from said first rotating body wherein said main line is in contact with said second rotating body and said second rotating body is adapted to retrieve the main line as it approaches said second rotating body.

17. The system according to claim 16, wherein the trip line is disconnected from the main line as said trip line approaches said second rotating body.

18. The system according to claim 16, wherein the leader line is disconnected from the main line as said leader line approaches said second rotating body.

19. The system according to claim 2, further comprising a second rotating body located downstream from said first rotating body wherein said main line is in contact with said second rotating body and said second rotating body is adapted to reroute the main line to said first rotating body.

20. The system according to claim 19, wherein the trip line is disconnected from the main line as said trip line approaches said second rotating body.

21. The system according to claim 20, wherein said trip line is reconnected to said main line as said trip line moves away from said second rotating body and towards said first rotating body.

22. The system according to claim 19, wherein the leader line is disconnected from the main line as said leader line approaches said second rotating body.

23. The system according to claim 22, wherein said leader line is reconnected to said main line as said trip line moves away from said second rotating body and towards said first rotating body.

24. A method for generating electric power from a fluid current comprising the steps of:
deploying into a fluid current drag elements operatively connected to a main line through leader lines and trip lines;
allowing said drag elements to move in the direction of the fluid current when a current-facing surface of said drag elements is exposed to said fluid current;
allowing at least a portion of said main line to move along with said drag elements in the direction of the water current; and
wherein said main line is adapted to be operatively connected to a rotating body used for generating electrical power.

25. The method according to claim 24, further comprising the step of rotating a first rotating body by allowing said moving main line to contact said rotating body.

26. The method according to claim 25, further comprising the step of driving an electric generator with said first rotating body.

27. A system for generating electric power from a fluid current, comprising:
a pliable sheet having a proximal end and a distal end;
said pliable sheet adapted to wrap around a drive axle;
said proximal end of said pliable sheet operatively connected to said drive axle;
said distal end of said pliable sheet detachably connected to an object a distance apart from said drive axle;
said pliable sheet adapted to unroll from said drive axle when deployed in a water current, wherein said unrolling of said pliable sheet from said drive axle causes rotation of said drive axle; and
said distal end of said pliable sheet adapted to detach from said object when said pliable sheet is substantially unrolled from said drive axle.
